(19) United States
(12) Patent Application Publication
(10) Pub. No.: US 2018/0037057 A1
(43) Pub. Date: Feb. 8, 2018

(54) SAFETY DEVICE FOR A VEHICLE WHEEL

(71) Applicant: PETER J. NORDINE, Queensville (CA)

(72) Inventor: PETER J. NORDINE, Queensville (CA)

(21) Appl. No.: 15/228,679

(22) Filed: Aug. 4, 2016

(51) Int. Cl. B60B 27/06; B60B 35/12

(52) U.S. Cl. CPC B60B 27/065; B60B 35/12; B60B 2360/104; B60B 2900/331

(57) ABSTRACT

A safety device for a truck, tractor, or trailer wheel assembly is an integral member with mounting holes for receiving axle studs of the wheel assembly to fix the integral member to the axle. The integral member has a radially extending portion which, when the integral member is fixed to the axle, overlaps the wheel studs of the wheel assembly but is free of any connection to the wheel studs. The integral member has tapered holes radially outbound of its mounting holes. In another embodiment, the integral member of the safety device has a cylindrical, interiorly threaded, sleeve portion and a radial portion extending radially outwardly from the sleeve portion with the radial portion having tapered holes radially outbound of the sleeve portion.

### BACKGROUND OF THE INVENTION

### Background

This invention relates to a safety device for a wheel assembly.

Truck, tractor, and trailer wheels pose a safety hazard because the rim or wheel studs of the wheel can fail when the vehicle is moving. This allows the wheel to fly free from the vehicle and endangers people and property.

This presents a need for safety devices that prevent wheels from flying away from trucks, tractors, and trailers when the wheel studs or wheel rim suffer mechanical failure.

Since this type of wheel rim and wheel stud failure is possible on many existing trucks, a desirable feature of this type of safety device is that it be capable of installation on existing truck, tractor, and trailer wheel assemblies. Further, it is desirable that a safety device for this purpose will not unduly interfere with the operation of, nor substantially increase the width of, the truck, tractor, or trailer.

### SUMMARY

A safety device for a wheel assembly is an integral member with mounting holes for receiving axle studs of the wheel assembly to fix the integral member to the axle. The integral member has a radially extending portion which, when the integral member is fixed to the axle, overlaps the wheel studs of the wheel assembly but is free of any connection to the wheel studs. The integral member has tapered holes radially outbound of its mounting holes. In another embodiment, the integral member of the safety device has a cylindrical, interiorly threaded, sleeve portion and a radial portion extending radially outwardly from the sleeve portion with the radial portion having tapered holes radially outbound of the sleeve portion.

In accordance with an aspect, there is provided a safety device for a wheel assembly, said assembly comprising an axle, a wheel rim, and a wheel hub with a plurality of axle studs extending through holes in an outer end of the axle, and a plurality of wheel studs retaining the wheel rim, said safety device comprising: an integral member having a plurality of mounting holes for receiving said axle studs to fix said integral member to said axle; said integral member having a radially extending portion; said radially extending portion, when said integral member is fixed to said axle, overlapping the wheel studs; said integral member, when fixed to said axle, free of any connection to the wheel studs; and said integral member having a plurality of tapered holes radially outbound of said mounting holes.

In accordance with another aspect, there is provided a wheel assembly comprising: an axle; a wheel rim; a wheel hub from which a plurality of axle studs project and extend through holes in an outer end of the axle, and from which a plurality of wheel studs project and retain the wheel rim; an integral safety device having a plurality of mounting holes receiving said axle studs to fix said safety device to said axle; said safety device having a radially extending portion overlapping the wheel studs; said safety device free of any connection to the wheel studs; and said safety device having a plurality of tapered holes radially outbound of said mounting holes.

In accordance with a further aspect, there is provided a safety device for a wheel assembly, comprising: an integral member having a cylindrical, interiorly threaded, sleeve portion; said integral member having a radial portion extending radially outwardly from said sleeve portion; said radial portion having a plurality of tapered holes radially outbound of said sleeve portion.

In accordance with a yet further aspect, there is provided a wheel assembly comprising: a wheel rim; a rotating wheel hub; a plurality of wheel studs retaining said wheel rim to said wheel hub; an integral safety device comprising: an axially-extending interiorly threaded sleeve portion threaded to the rotating wheel hub; a radially extending portion, said radially extending portion overlapping the wheel studs; said integral member free of any connection to the wheel studs; said radially extending portion having a plurality of tapered holes radially outbound of said sleeve.

### BRIEF DESCRIPTION OF THE DRAWINGS

In the drawings which illustrate embodiments:

FIG. 1 is an exploded perspective view of a truck wheel assembly and safety device in accordance with an embodiment;

FIG. 2 is a cross-sectional assembled view of the truck wheel assembly and safety device of FIG. 1;

FIG. 3 is a magnified view of the portion labeled 3 in FIG. 2;

FIG. 4 is a front perspective view of the safety device of FIG. 1;

FIG. 5 is a front view of the safety device of FIG. 4;

FIG. 6 is a back view of the safety device of FIG. 4;

FIG. 7 is a side view of the safety device of FIG. 4;

FIG. 8 is a cross-sectional view of a trailer wheel having a safety device in accordance with a second embodiment;

FIG. 9 is a front perspective view of the safety device of FIG. 8;

FIG. 10 is a back perspective view of the safety device of FIG. 8;

FIG. 11 is a front view of the safety device of FIG. 8; and

FIG. 12 is a back view of the safety device of FIG. 8.

### DETAILED DESCRIPTION

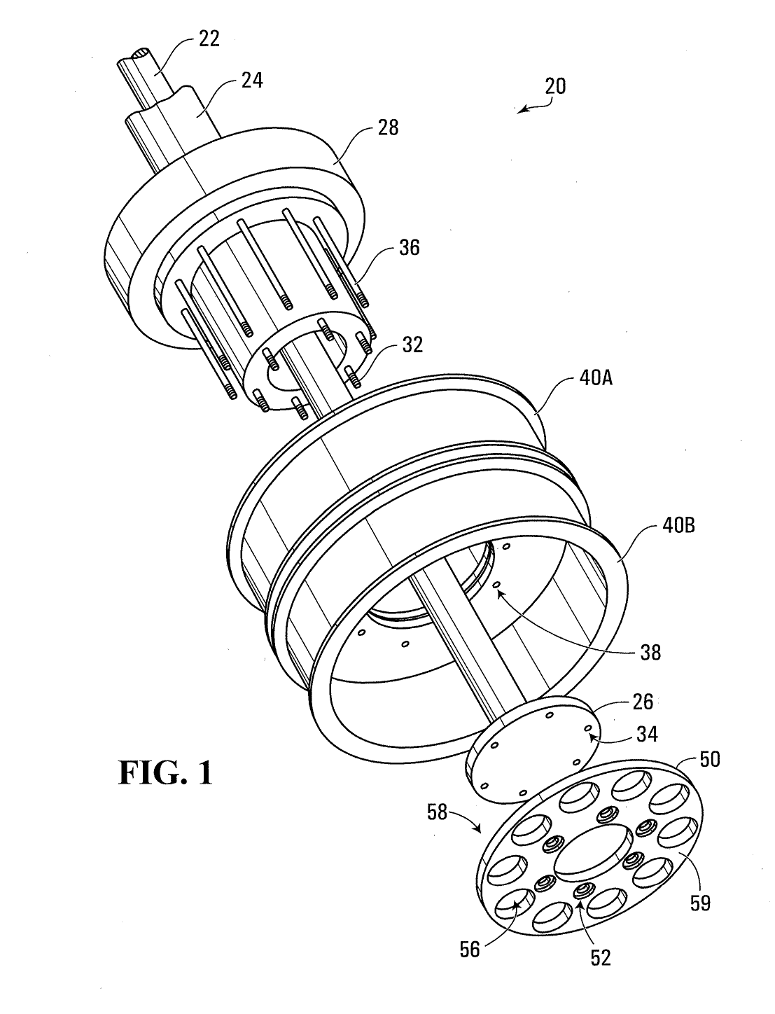

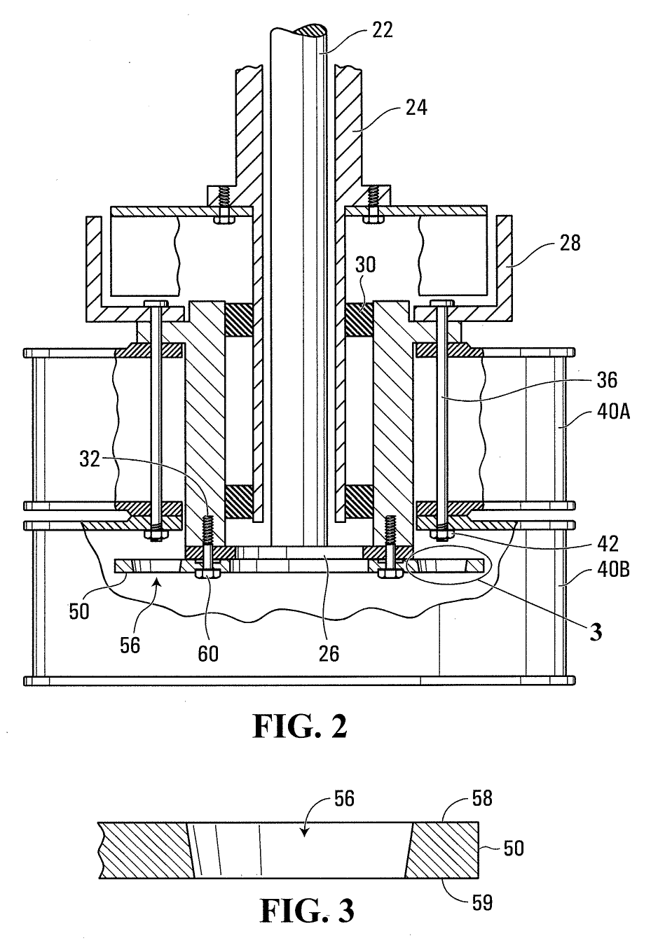

Referring to FIGS. 1 and 2, in a first embodiment, a driving wheel assembly 20 has an axle with an axle shaft 22 which extends through a stationary axle housing 24 and terminates in an axle end cap 26. A wheel hub 28 is supported for rotation on the axle housing 24 by bearings 30 and is attached to the outer end of the axle by means of axle studs 32 which are threaded to the wheel hub and pass through holes 34 in the axle end cap 26. Wheel studs 36 protrude from wheel hub 28, pass through holes 38 in wheel rims 40a, 40b, and are joined to the wheel rims by nuts 42.

A brake assembly—namely brake drums or disks with calipers (not shown)—is disposed within wheel rim 40a.

As seen in FIG. 2, a safety device 50 abuts the axle end cap 26 of the axle.

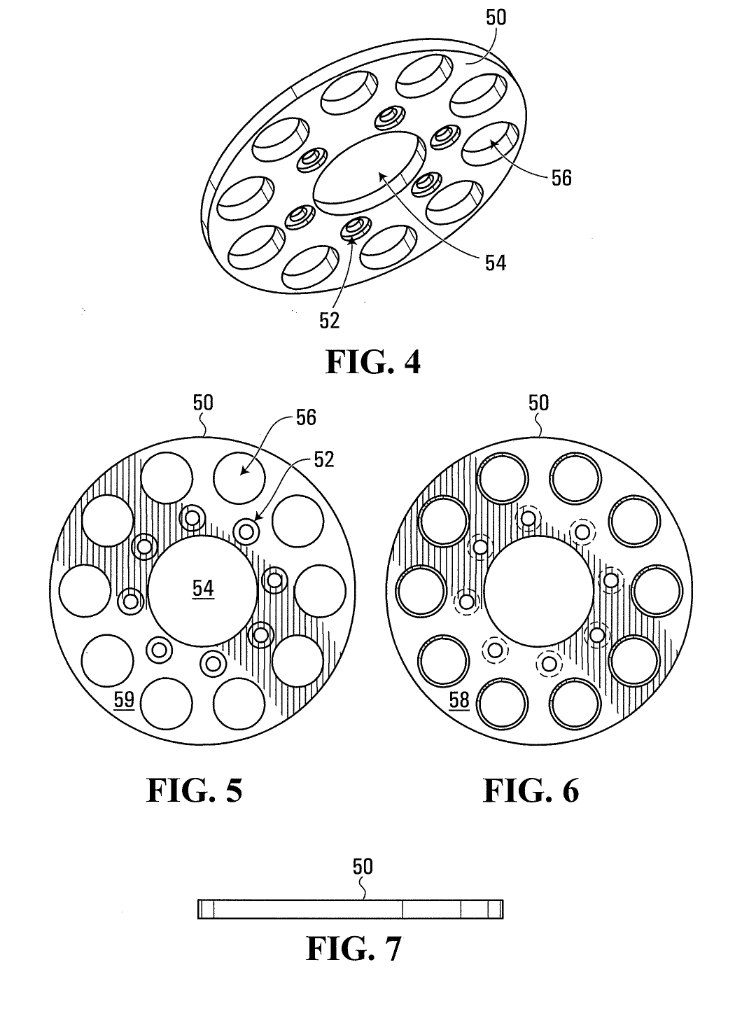

Turning to FIGS. 3 to 7, the safety device 50 is an integral member in the nature of a radially extending disk which may be formed from aluminum at least ⅜″ thick. The safety device has countersunk mounting holes 52 extending about a central opening 54. The safety device has tapered holes 56 positioned radially outbound of mounting holes 52 and arranged in a circular pattern. The tapered holes may have a taper angle of about 15° and taper from a larger diameter at the back face 58 of the safety device to a smaller diameter at the front face 59 of the safety device.

By way of example, the disk may be about ⅝″ thick and the tapered holes may taper from a diameter of about 3⅝″ at the back face of the safety device to a diameter of about 3¼″ at the front face of the safety device such that the tapered holes are about 10% larger at the back face of the safety device.

Returning to FIGS. 1 and 2, the safety device is positioned against the axle end cap 26 so that the axle studs 32 extend through the mounting holes 52 in the safety device. In this regard, the safety device is oriented so that the back face 58 of the safety device—having the wider diameter end of tapered holes 56—faces the wheel hub 28. Nuts 60 (FIG. 2) are then threaded to the axle studs 32 to fixedly retain the safety device in abutting relationship with the axle end cap 26. The radially extending safety device overlaps the wheel studs 36 but is free of any connection to the wheel studs 36. Further, the safety device is constructed so that when it is mounted to the axle end cap, each tapered hole 56 is axially aligned with one wheel stud 36.

Sometimes an axle cap 26 of a truck wheel assembly 20 has a protruding centre. The central hole 54 of the safety device 50 is sized for receiving any protruding portion of such an axle cap 26.

As a truck fitted with the described truck wheel assembly and safety device is driven, the safety device rotates with the axle 22. In consequence, the tapered holes 56 of the safety device cut the air, which results in air being forced through the tapered holes, from the smaller diameter end of the holes at the front face 59 of the safety device to their larger diameter end at the back face 58 of the safety device. With the back face 58 of the safety device facing the wheel hub 28, the forced air flows inwardly to impact the brake assembly within the wheel rim. This cools the brake assembly which reduces brake fade and increases brake life.

Additionally, by axially aligning the tapered holes 56 with the wheel studs 36, the tapered holes provide access points for removing the nuts 42 from the wheel studs 36. Indeed, by judiciously sizing the minor diameter of the tapered holes, these holes may closely fit the extension piece of a tool used to remove nuts 42 in order to assist in maintaining alignment of the extension piece.

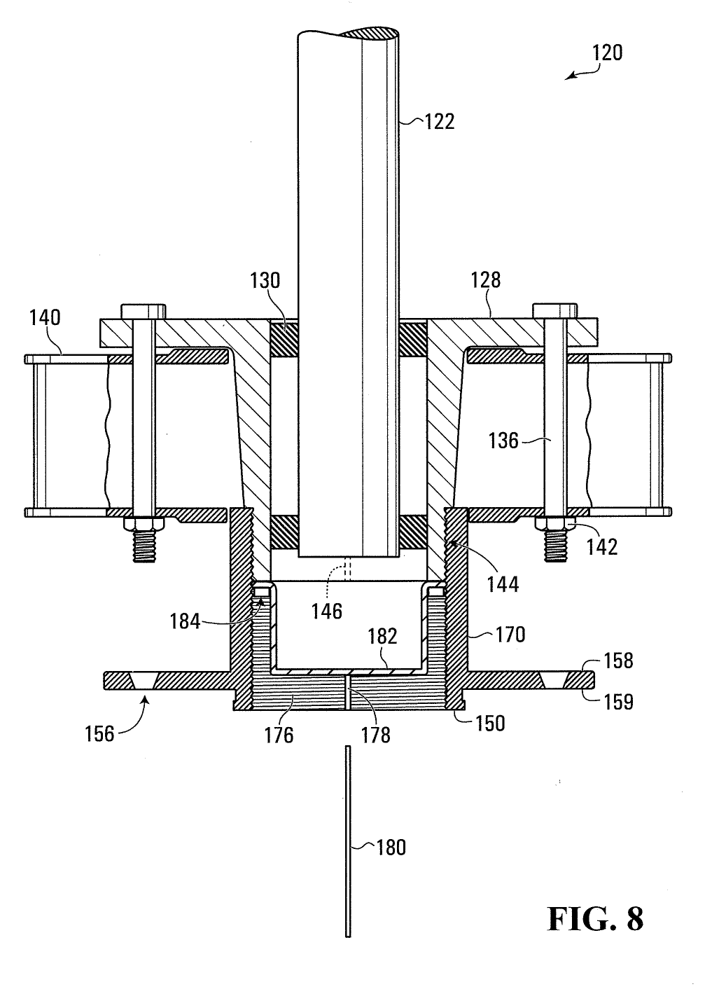

In a second embodiment, a safety device is provided for a truck idler wheel assembly as is typically found on a non-driven wheel, such as a trailer wheel. Referring to FIG. 8, in the second embodiment, a wheel hub 128 is mounted by bearings 130 to axle shaft 122 of wheel assembly 120. A plurality of wheel studs 136 extend from the wheel hub 128 and pass through a wheel rim 140. Nuts 142 hold the wheel rim to the wheel studs. The outer end of the exterior surface of the wheel hub 128 has a threaded portion 144 interrupted by a keyway 146. The wheel hub 128 may be manufactured with such a thread and keyway or the thread may be die cut into a wheel hub already installed on a truck and the keyway machined into the threaded portion of the wheel hub.

A brake assembly (not shown) is disposed within the wheel rim 140.

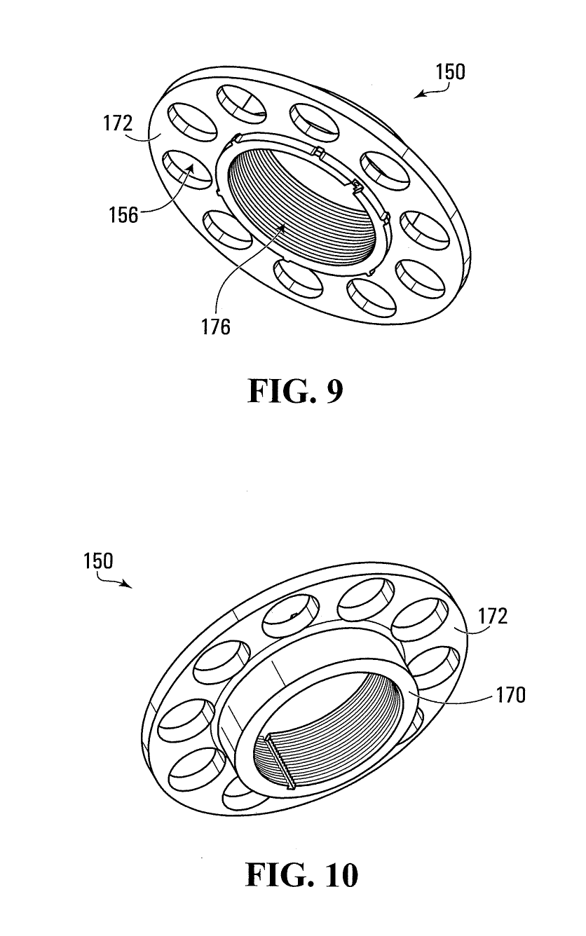

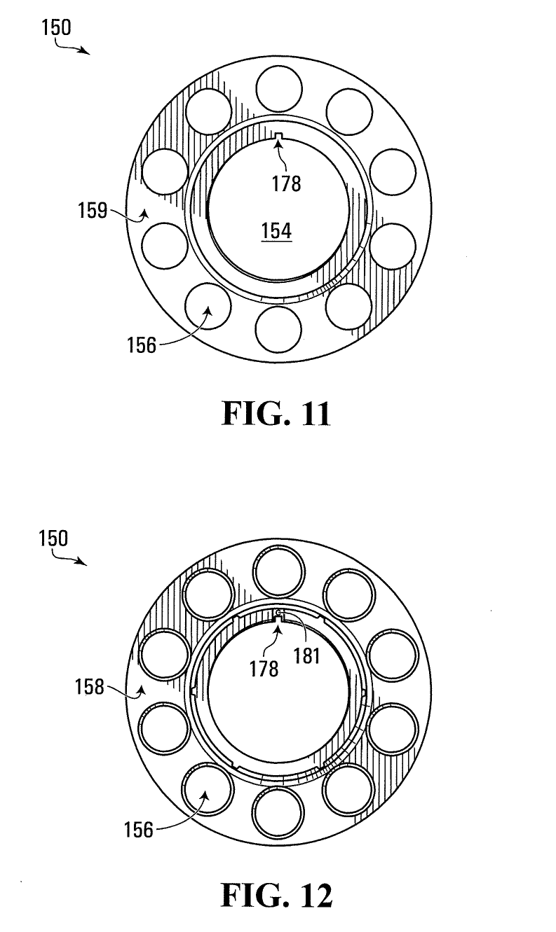

Referencing FIGS. 9 to 12 along with FIG. 8, a safety device 150 is an integral member with a cylindrical sleeve portion 170 and a radial portion 172 proximate one end of the sleeve portion extending radially outwardly from the sleeve portion 170. The sleeve portion 170 has interior threads 176 which threads are interrupted by a keyway 178. The radial portion 172 has a plurality of tapered holes 156 radially outbound of the sleeve portion 170 and arranged in a circular pattern. The tapered holes may have a taper angle of about 15° and taper from a larger diameter at the back face 158 of the radial portion 172 to a smaller diameter at the front face 159 of the radial portion 172.

Again, the integral safety device is preferably formed of aluminum, at least ⅝ inches thick.

By way of example, and similarly to the first embodiment, the radial portion 172 may be about ⅝″ thick and the tapered holes may taper from a diameter of about 3⅝″ at the back face of the radial portion of the safety device to a diameter of about 3¼″ at the front face of the radial portion of the safety device such that the tapered holes are about 10% larger at the back face.

With reference to FIG. 8, the safety device may be mounted by threading the sleeve portion 170 over the threaded portion of the wheel hub 128 such that the back surface 158 of the radial portion 172 faces the wheel hub. The sleeve portion is threaded to the wheel hub until the keyway 178 of the safety device is aligned with the keyway 146 of the wheel hub; a key 180 is then inserted into the aligned keyways to lock the sleeve to the wheel hub 128. A bolt (not shown) is then threaded into threaded hole 181 (FIG. 12) of the safety device so that the head of the bolt retains the key 180 in place. It will be apparent that, when the safety device is mounted to the wheel hub 128, the radial portion 172 of the safety device overlaps the wheel studs 136 but is free of any connection to the wheel studs 136. Further, the safety device can be constructed so that when it is mounted (and locked) to the wheel hub, each tapered hole 156 is axially aligned with one wheel stud 136 in order to facilitate torquing, re-torquing and removal of the nuts 142, as has been described in conjunction with the first embodiment.

An axle cap 182 covers the outer end of the axle 122 and is bolted by bolts 184 to wheel hub 128. The safety device 150 defines a central hole 154 that receives the axle cap 182.

In use, as a truck idler wheel mounted to rim 140 rotates, the wheel hub 128 rotates on (stationary) axle 122. The safety device 150, which is locked to the wheel hub, rotates with the wheel hub. In the event of failure of the wheel studs 136 or the wheel rim 140, the safety device acts to prevent the wheel and wheel rim from leaving the vehicle.

It will be apparent to those skilled in the art, that certain components of conventional truck wheel assemblies have been omitted from the drawings and from this description.

Those skilled in the art will find obvious certain variations of the disclosed embodiments. For example, the direction of the taper of tapered holes 56, 156 in the safety device could be reversed such that the large diameter end of these holes is at the front face of the safety device. With this modification, air will be drawn away from the wheel hub and rim rather than being forced toward the hub and rim. With this modification, the safety device will still act to cool the brakes. More specifically, as the brakes heat up, they will heat the air around the hub and rim: by drawing off this hot air, the hot air will be replaced with cooler air and the brakes will be cooled.

What is claimed is:

1. A safety device for a wheel assembly, said assembly comprising an axle, a wheel rim, and a wheel hub with a plurality of axle studs extending through holes in an outer end of the axle, and a plurality of wheel studs retaining the wheel rim, said safety device comprising:
an integral member having a plurality of mounting holes for receiving said axle studs to fix said integral member to said axle;
said integral member having a radially extending portion;
said radially extending portion, when said integral member is fixed to said axle, overlapping the wheel studs;
said integral member, when fixed to said axle, free of any connection to the wheel studs; and
said integral member having a plurality of tapered holes radially outbound of said mounting holes.

2. The safety device of claim 1 wherein, when said integral member is fixed to said axle, said tapered holes are larger at a back face of said integral member, said back face facing said wheel hub.

3. The safety device of claim 1 wherein each of said tapered holes has a taper angle of about 15°.

4. The safety device of claim 2 wherein each of said tapered holes has a taper angle of about 15°.

5. The safety device of claim 1 wherein said tapered holes are positioned so that, when said integral member is fixed to said axle, each tapered hole of said tapered holes is axially aligned with a wheel stud of said plurality of wheel studs.

6. The safety device of claim 1 wherein said tapered holes are arranged in a circular pattern.

7. The safety device of claim 1 wherein said integral member is not less than ⅝″ thick.

8. The safety device of claim 1 wherein said integral member is about ⅝″ thick, each of said tapered holes has a diameter of about 3¼″ at one face of said integral member and a diameter of about 3⅝″ at an opposite face of said integral member.

9. The safety device of claim 1 wherein said integral member further defines a centre hole.

10. The safety device of claim 1 in which the integral member is formed from aluminum.

11. A wheel assembly comprising:
an axle;
a wheel rim;
a wheel hub from which a plurality of axle studs project and extend through holes in an outer end of the axle, and from which a plurality of wheel studs project and retain the wheel rim;
an integral safety device having a plurality of mounting holes receiving said axle studs to fix said safety device to said axle;
said safety device having a radially extending portion overlapping the wheel studs;
said safety device free of any connection to the wheel studs; and
said safety device having a plurality of tapered holes radially outbound of said mounting holes.

12. The assembly of claim 11 wherein said tapered holes are larger at a back face of said safety device, said back face facing said wheel hub.

13. The safety device of claim 12 wherein each of said tapered holes has a taper angle of about 15°.

14. A safety device for a wheel assembly, comprising:
an integral member having a cylindrical, interiorly threaded, sleeve portion;
said integral member having a radial portion extending radially outwardly from said sleeve portion;
said radial portion having a plurality of tapered holes radially outbound of said sleeve portion.

15. The safety device of claim 14 wherein, when said integral member is threaded to a rotating wheel hub of a wheel assembly having a rotating wheel hub, a wheel rim, and a plurality of wheel studs retaining said wheel rim to said wheel hub, said integral member is oriented so that said tapered holes are smaller at a face of said radially extending portion of said integral member facing said wheel hub.

16. The safety device of claim 14 wherein each of said tapered holes has a taper angle of about 15°.

17. The safety device of claim 15 wherein each of said tapered holes has a taper angle of about 15°.

18. The safety device of claim 15 wherein, when said integral member is threaded to said rotating wheel hub, each tapered hole of said tapered holes is axially aligned with a wheel stud of said plurality of wheel studs.

19. The safety device of claim 15 wherein said tapered holes are arranged in a circular pattern.

20. The safety device of claim 15 further comprising a keyway axially-extending along said interiorly threaded sleeve of said integral member for aligning with a keyway of said threaded wheel hub and further comprising a key for insertion in said keyway of said sleeve and said keyway of said wheel hub.

21. A wheel assembly comprising:
a wheel rim;
a rotating wheel hub;
a plurality of wheel studs retaining said wheel rim to said wheel hub;
an integral safety device comprising:
an axially-extending interiorly threaded sleeve portion threaded to the rotating wheel hub;
a radially extending portion, said radially extending portion overlapping the wheel studs;
said integral member free of any connection to the wheel studs;
said radially extending portion having a plurality of tapered holes radially outbound of said sleeve.

22. The assembly of claim 21 wherein said tapered holes are smaller at a face of said radially extending portion of said integral member facing said wheel hub.

23. The safety device of claim 21 wherein each of said tapered holes has a taper angle of about 15°.

24. The safety device of claim 22 wherein each of said tapered holes has a taper angle of about 15°.

25. The safety device of claim 21 wherein each tapered hole of said tapered holes is axially aligned with a wheel stud of said plurality of wheel studs.
